(19) United States
(12) Patent Application Publication
(10) Pub. No.: US 2014/0042131 A1
(43) Pub. Date: Feb. 13, 2014

(54) LASER WELDING CONSUMABLE

(71) Applicant: LINCOLN GLOBAL, INC., City of Industry, CA (US)

(72) Inventor: Elliott ASH, Bay Village, OH (US)

(73) Assignee: LINCOLN GLOBAL, INC., City of Industry, CA (US)

(21) Appl. No.: 13/795,067

(22) Filed: Mar. 12, 2013

Related U.S. Application Data
(60) Provisional application No. 61/681,971, filed on Aug. 10, 2012.

(51) Int. Cl. B23K 1/005; B23K 35/02

(52) U.S. Cl. CPC B23K 1/0056; B23K 35/0261
USPC 219/121.66; 219/121.65; 428/576

(57) ABSTRACT

A system and method for heating a filler wire (consumable) using a laser in brazing, cladding, building up, filling, overlaying, welding, and joining applications. The filler wire includes a first surface that absorbs energy from a laser beam and a second surface separated from said first surface by a thickness t that is in a range of 0.010 inch to 0.045 inch. A cross-sectional shape of the filler wire includes at least one bend toward the laser beam along a length of the cross-sectional shape. The cross-sectional shape has a projected width w that is in a range of 0.030 inch to 0.095 inch.

### PRIORITY

The present application claims priority to U.S. Provisional Patent Application No. 61/681,971 filed Aug. 10, 2012, which is incorporated herein by reference in its entirety.

### TECHNICAL FIELD

Certain embodiments relate to filler wire (consumable) for brazing, cladding, building up, filling, hard-facing overlaying, welding, and joining applications. More particularly, certain embodiments relate to filler wires that can be used with a system and method that uses a laser to heat the filler wire in a system for any of brazing, cladding, building up, filling, hard-facing overlaying, joining, and welding applications.

### BACKGROUND

The traditional filler wire method of welding (e.g., a gas-tungsten arc welding (GTAW) filler wire method) can provide increased deposition rates and welding speeds over that of traditional arc welding alone. In such welding operations, the filler wire, which leads a torch, can be resistance-heated by a separate power supply. The wire is fed through a contact tube toward a workpiece and extends beyond the tube. The extension is resistance-heated to aid in the melting of the filler wire. A tungsten electrode may be used to heat and melt the workpiece to form the weld puddle. A power supply provides a large portion of the energy needed to resistance-melt the filler wire. In some cases, the wire feed may slip or falter and the current in the wire may cause an arc to occur between the tip of the wire and the workpiece. The extra heat of such an arc may cause burnthrough and spatter resulting in poor weld quality.

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention comprise a system and method to use a laser to heat at least one filler wire in a system for any of brazing, cladding, building up, filling, hard-facing overlaying, welding, and joining applications, and the filler wire itself. The filler wire includes a first surface that absorbs energy from a laser beam and a second surface separated from said first surface by a thickness t that is in a range of 0.010 inch to 0.045 inch. A cross-sectional shape of the filler wire includes at least one bend toward the laser beam along a length of the cross-sectional shape. The cross-sectional shape has a width w that is in a range of 0.030 inch to 0.095 inch.

The system includes a high intensity heat source that heats a workpiece to create a molten puddle and a feeder system that feeds said filler wire to the molten puddle. The system also includes a laser system that emits a laser beam to heat a length of the filler wire prior to the filler wire entering the molten puddle.

The method includes heating a workpiece to create a molten puddle and feeding the filler wire to the molten puddle. The method also includes heating a length of the filler wire using a laser beam prior to the filler wire entering the molten puddle, The method also includes applying energy from a high intensity energy source to the workpiece to heat the workpiece at least while using a laser to heat the at least one filler wire. The high intensity energy source may include at least one of a laser device, a plasma arc welding (PAW) device, a gas tungsten arc welding (GTAW) device, a gas metal arc welding (GMAW) device, a flux cored arc welding (FCAW) device, and a submerged arc welding (SAW) device.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1 illustrates a functional schematic block diagram of an exemplary embodiment of a combination filler wire feeder and energy source system for any of brazing, cladding, building up, filling, hard-facing overlaying, welding, and joining applications;

FIG. 2 illustrates a related art filler wire geometry;

FIG. 3 illustrates an exemplary embodiment of a filler wire geometry that can be used in the embodiments of the present invention;

FIG. 4 illustrates a diagram of an exemplary laser and wire arrangement that can be used in the system of FIGS. 1; and

FIGS. 5A-5D are exemplary embodiments of filler wire geometries that can be used in the present invention.

### DETAILED DESCRIPTION

Exemplary embodiments of the invention will now be described below by reference to the attached Figures. The described exemplary embodiments are intended to assist in the understanding of the invention, and are not intended to limit the scope of the invention in any way. Like reference numerals refer to like elements throughout.

It is known that welding/joining operations typically join multiple workpieces together in a welding operation where a filler metal is combined with at least some of the workpiece metal to form a joint. Because of the desire to increase production throughput in welding operations, there is a constant need for faster welding operations, which do not result in welds which have a substandard quality. This is also true for cladding/surfacing operations, which use similar technology. It is noted that although much of the following discussions will reference “welding” operations and systems, embodiments of the present invention are not just limited to joining operations, but can similarly be used for cladding, brazing, overlaying, etc.—type operations. Furthermore, there is a need to provide systems that can weld quickly under adverse environmental conditions, such as in remote work sites. As described below, exemplary embodiments of the present invention provide significant advantages over existing welding technologies. Such advantages include, but are not limited to, reduced total heat input resulting in low distortion of the workpiece, very high welding travel speeds, very low spatter rates, welding with the absence of shielding, welding plated or coated materials at high speeds with little or no spatter and welding complex materials at high speeds.

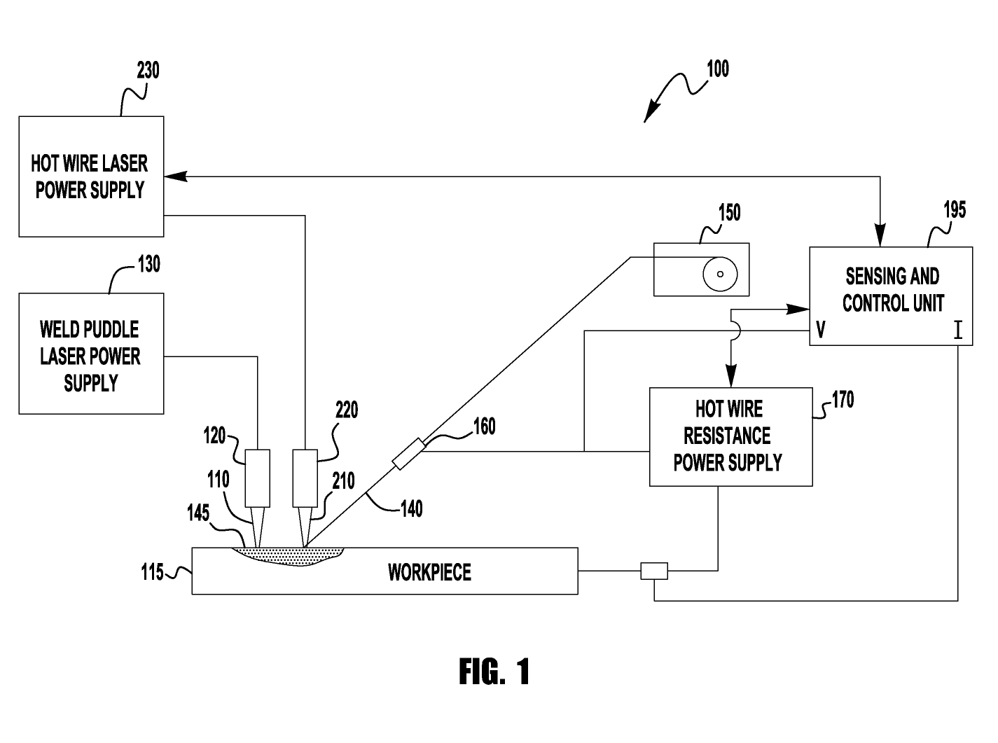

FIG. 1 illustrates a functional schematic block diagram of an exemplary embodiment of a combination filler wire feeder and energy source system 100 for performing any of brazing, cladding, building up, filling, hard-facing overlaying, and joining/welding applications. The system 100 includes a high energy heat source capable of heating the workpiece 115 to form a weld puddle 145. The high energy heat source can be a laser subsystem 130/120 that includes a laser device 120 and a weld puddle laser power supply 130 operatively connected to each other. The laser 120 is capable of focusing a laser beam 110 onto the workpiece 115 and the power supply 130 provides the power to operate the laser device 120. The laser subsystem 130/120 can be any type of high energy laser source, including but not limited to carbon dioxide, Nd:YAG, Yb-disk, YB-fiber, fiber delivered, or direct diode laser systems. Further, even white light or quartz laser type systems can be used if they have sufficient energy. For example, a high intensity energy source can provide at least 500 W/cm².

The following discussion will repeatedly refer to the laser subsystem 130/120, beam 110 and weld puddle laser power supply 130, however, it should be understood that this reference is exemplary as any high intensity energy source may be used. For example, other embodiments of the high energy heat source may include at least one of an electron beam, a plasma arc welding subsystem, a gas tungsten arc welding subsystem, a gas metal arc welding subsystem, a flux cored arc welding subsystem, and a submerged arc welding subsystem. It should be noted that the high intensity energy sources, such as the laser device 120 discussed herein, should be of a type having sufficient power to provide the necessary energy density for the desired welding operation. That is, the laser device 120 should have a power sufficient to create and maintain a stable weld puddle throughout the welding process, and also reach the desired weld penetration. For example, for some applications, lasers should have the ability to “keyhole” the workpieces being welded. This means that the laser should have sufficient power to fully penetrate the workpiece, while maintaining that level of penetration as the laser travels along the workpiece. Exemplary lasers should have power capabilities in the range of 1 to 20 kW, and may have a power capability in the range of 5 to 20 kW. Higher power lasers can be utilized, but can become very costly.

The system 100 also includes a hot filler wire feeder subsystem capable of providing at least one filler wire (consumable) 140 to make contact with the workpiece 115 in the vicinity of the laser beam 110. Of course, it is understood that by reference to the workpiece 115 herein, the molten puddle, i.e., weld puddle 145 is considered part of the workpiece 115, thus reference to contact with the workpiece 115 includes contact with the weld puddle 145. The hot filler wire feeder subsystem includes a filler wire feeder 150, contact tube 160, a hot wire resistance power supply 170, and a hot wire laser subsystem 230/220. The hot wire laser subsystem includes a laser 220 which is powered by hot wire laser power supply 230. The hot wire laser subsystem 230/220 can be any type of high energy laser source, including but not limited to carbon dioxide, Nd:YAG, Yb-disk, YB-fiber, fiber delivered or direct diode laser systems. Again, even white light or quartz laser type systems can be used if they have sufficient energy.

During operation, the wire 140 is fed from the filler wire feeder 150 toward the workpiece 115 and extends beyond contact tube 160. Prior to its entry into weld puddle 145 on the workpiece 115, the extended portion of filler wire 140 is heated by laser beam 210 from laser 220 such that wire 140 approaches or reaches its melting point before contacting the weld puddle 145. Unlike most welding processes, the present invention melts the filler wire 140 into the weld puddle 145 rather than using a welding arc to transfer the filler wire 140 into the weld puddle 145. Because the filler wire 140 is heated to at or near its melting point by laser beam 210, its presence in the weld puddle 145 will not appreciably cool or solidify the puddle 145 and the wire 140 is quickly consumed into the weld puddle 145.

In some exemplary embodiments, the wire 140 is preheated to a predetermined threshold temperature by hot wire resistance power supply 170. Power supply 170 sends a current through the wire 140 via contact tube 160 and the current resistance heats the extended portion of the wire 140 to the predetermined threshold temperature. In some non-limiting embodiments, the threshold temperature is selected such that the current needed to maintain the wire 140 at the threshold temperature will not create an arc if the wire 140 loses contact with the workpiece 115. In exemplary embodiments, the wire 140 is preheated by power supply 170 to a temperature that is greater than 50% of its meting temperature. In some other embodiments, the wire 140 is preheated to between 75-95% of its melting temperature by power supply 170. Because the current from resistance power supply 170 is below the level for arc creation, the possibility of inadvertently forming an arc between the wire 140 and the workpiece 115 is nearly zero. As the filler wire 140 is fed to the weld puddle 145, at least a portion of the wire 140 that extends beyond contact tube 160 is then heated to at or near its melting point by the laser beam 210.

Of course, the melting temperature of the filler wire 140 will vary depending on the size and chemistry of the wire 140. Accordingly, the desired temperature of the filler wire during welding will vary depending on the wire 140. As will be further discussed below, the desired operating temperature for the filler wire 140 can be a data input into the welding system so that the desired wire temperature is maintained during welding. In any event, the temperature of the wire 140 should be such that the wire 140 is consumed into the weld puddle 145 during the welding operation. In exemplary embodiments, at least a portion of the filler wire 140 is solid as it enters the weld puddle 145. For example, at least 30% of the filler wire 140 is solid as the filler wire 140 enters the weld puddle 145.

Because no welding arc is needed to transfer the filler wire in the process described herein, the feeder subsystem may be capable of simultaneously providing one or more wires, in accordance with certain other embodiments of the present invention. For example, a first wire may be used for hard-facing and/or providing corrosion resistance to the workpiece, and a second wire may be used to add structure to the workpiece. In addition, by directing more than one filler wire to any one weld puddle, the overall deposition rate of the weld process can be significantly increased without a significant increase in heat input. Thus, it is contemplated that open root weld joints can be filled in a single weld pass.

As described above, the filler wire 140 impacts the same weld puddle 145 as the laser beam 110. In some exemplary embodiments, the filler wire 140 can impact the same weld puddle 145 remotely from the laser beam 110. However, in other exemplary embodiments, the filler wire 140 impacts the weld puddle 145 at the same location as the laser beam 110. In this case, the laser beam 110, which serves to melt some of the workpiece 115 to from the weld puddle 145, may also aid laser beam 210 (and power supply 170 in some exemplary embodiments) in melting the filler wire 140. Additionally, in some exemplary embodiments, the weld puddle 145 will help melt the filler wire 140. While the laser 120 and power supply 170 may provide some energy to melt the wire 140, in some exemplary embodiments of the present invention, the laser 220 will provide a large portion of the energy needed to melt the filler wire 140. In some exemplary embodiments, the laser beam 210 may provide 5 to 75% of the energy needed to melt filler wire 140. In some embodiments, the laser beam 210 will provide 10-35% of the energy needed to melt the wire 140. By supplying a lesser amount of the heat energy needed to melt the wire 140, the laser 220 and power supply 230 can be a relatively low power level supply and thus not as expensive. Further, by supplementing the heat needed to melt the wire 140 with the laser 220 and beam 210 there is a reduced risk of the power supply 170 causing an arc to be created between the wire 140 and the puddle 145 during operation—which can be undesirable. For example, in an embodiment of the present invention, the power supply 170 can provide a heating current to the wire 140 which heats the wire 140 to between 75 and 95% of its melting point, where the laser 220 provides the remaining percentage of heating energy needed to make the wire 140 nearly molten as it enters the puddle 145. In such a system the laser 220 is a relatively low power laser and the risk of arcing is reduced because the current provided by the power supply 170 is less than a current level that can create or maintain an arc.

For example, in some embodiments of the present invention, the heating current provided by the power supply 170 is in the range of 60 to 95% of the current needed to sustain an arc between the wire 140 and the workpiece 115. The remaining heating for the wire 140—to heat it at or near its melting temperature—comes from the laser 220.

In exemplary embodiments of the present invention, the wire heating laser beam 210 is configured and directed such that it only impacts the wire 140 during operation and does not add any additional heat to the puddle 145 during the operation. In these embodiments, the beam 210 is emitted with a cross-sectional shape and focus such that the beam 210 does not impact the puddle 145. For example, the beam 210 can have a cross-sectional shape—at the point of impact on the wire 140—which has a maximum width (in a direction normal to the centerline of the wire) in the range of 50 to 95% of the diameter of the wire 140. Such a cross-sectional dimension ensures that none of the beam 210 energy impacts the puddle 145. In other exemplary embodiments, the impact of beam 210 on weld puddle 145 may be less of a concern. In such embodiments, the cross-sectional shape of the laser beam 210 will have a width that is equal to or greater than the diameter of the wire 140 to ensure that all sections of the wire 140 are heated. In such embodiments, the laser 220 and beam 210 can be used to provide additional heating to the puddle 145.

In the embodiment shown in FIG. 1, the filler wire 140 trails the laser beam 110 during the welding operation. However, that is not necessary as the filler wire 140 can be positioned in the leading position. The present invention is not limited in this regard, as the filler wire 140 can be positioned at other positions relative to the beam 110 so long as the filler wire 140 impacts the same weld puddle 145 as the beam 110.

The system 100 may include a sensing and control unit 195 which is used to control the operation of the power supplies 170, 230 and 130, as well as the wire feeder 150. The operation of the sensing and control unit 195 is disclosed and discussed in co-pending application Ser. No. 13/212,025, titled “Method And System To Start And Use Combination Filler Wire Feed And High Intensity Energy Source For Welding” and incorporated by reference in its entirety, and will therefore not be discussed in detail herein.

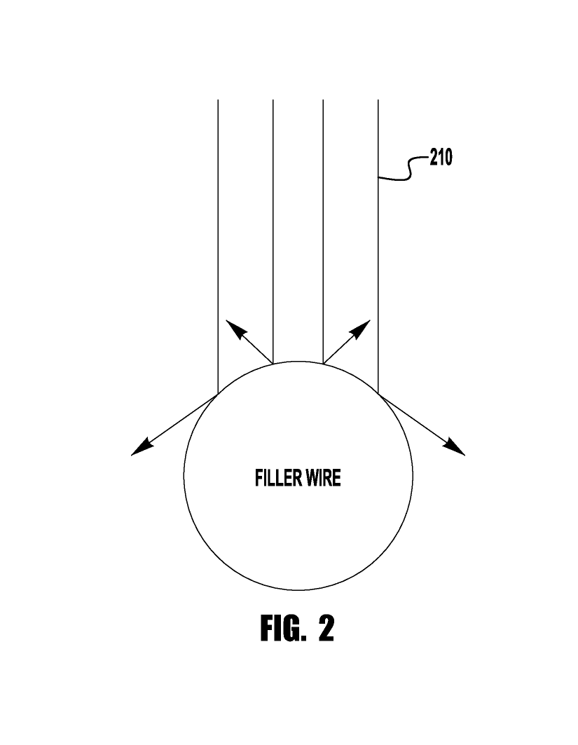

Typically, filler wires have a round cross-sectional area. Because of this round cross-section, a large portion of the laser beam 210 hits the surface of filler wire at incident angles that are less than optimal (see FIG. 2). As shown in FIG. 2, the surface of the filler wire curves away from the laser beam 210. Accordingly, much of the energy from laser beam 210 may be scattered rather than being absorbed by the filler wire. Furthermore, because of the circular cross-section a large portion of the surface area of the wire 140 will not be impacted by the beam 210, and the thickness of the wire can prevent even heating by the laser beam 210 such that the surface closest to the beam will have a higher temperature than the surface of the wire shielded from the beam. This uneven heating can inhibit even melting of the wire in the puddle. Because an appreciable portion of the laser beam 210 may not be helping to heat the filler wire, a larger than optimal laser 220 may need to be used in order to take into account this inefficiency. In addition, this inefficiency problem can be further compounded due to the reflective nature of many filler wires. Preheating the filler wire using current from the power supply 170 as discussed above will help by reducing the wire's surface reflectivity and allowing the laser beam 210 to contribute to the heating/melting of the filler wire. However, consistent with embodiments of present invention, the effectiveness of laser beam 210 can be further enhanced by using a filler wire geometry that optimizes the incident angle of the laser beam 210.

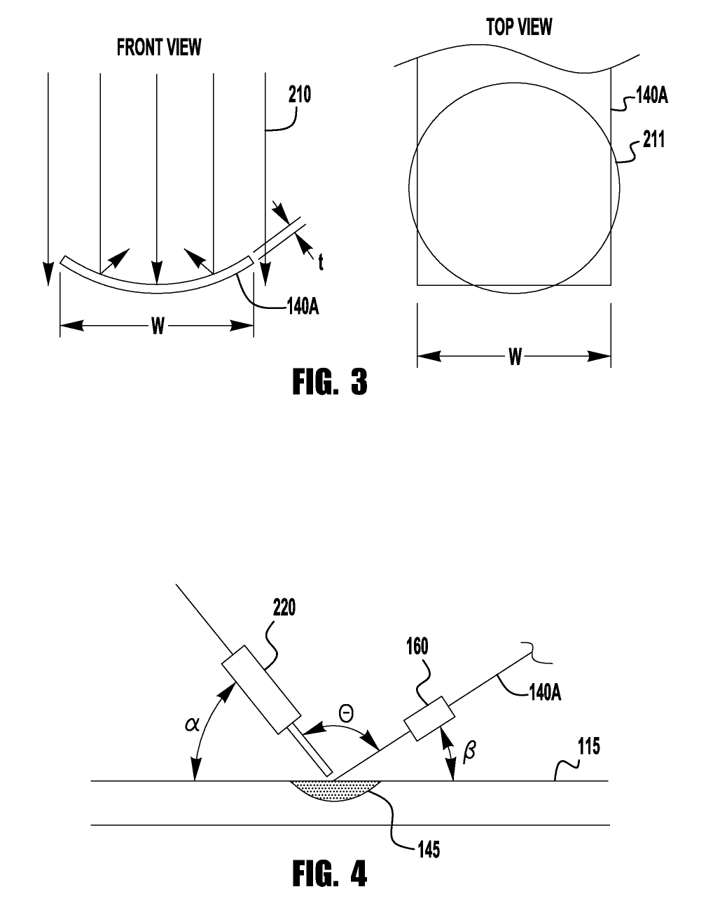

FIG. 3 illustrates an exemplary embodiment of a filler wire that may be used in the system of FIG. 1. As shown in FIG. 3, filler wire 140A has an arc or curved cross-section with thickness t. In this embodiment, the top surface of the wire 140A curves towards the laser 220 (not shown). Because of the overall shape of the wire 140A, the wire 140A can capture more of the beam 210 and thus more efficient and even heating of the wire 140A by the beam 210 can be achieved. For example, the thickness t of the wire 140A is chosen such that the heating from the beam 210 at the upper surface of the wire 140A can quickly transfer to the bottom of the wire 140A to ensure efficient consumption in the weld puddle 145. Accordingly, as compared to a system using filler wire with a circular cross-sectional area as shown in FIG. 2, a system using wire 140A can use a smaller (less power) laser power supply 230 and achieve the same results, and with more even heating of the wire 140A. In exemplary embodiments of the present invention, the maximum thickness of the wire 140A is in the range of 0.010 to 0.045 inches.

As shown in FIG. 3, the laser beam 210 is focused on the top surface of the wire 140A and the incident beam 210 has a width at the point of impact 211 which is wider than the maximum width of the wire 140A as projected onto a plane, e.g., as seen from the point of view of the laser (see Top View of FIG. 3). In other embodiments (as discussed above) the maximum width of the beam 210 at the point of impact 210 is less than the projected width w of the wire 140A. In some embodiments, the maximum width of the beam 210 at the point of impact 211 matches the projected width w of the wire 140A. By having the width of the beam 210 at the point of impact 211 larger than the projected width w of wire 140A, at least some of the energy of the beam 210 can be used to add heating to the puddle 145. As explained above, in other exemplary embodiments, the width of the beam 210 at the point of impact 211 is smaller than width w and the laser beam 210 may be scanned across the top surface of wire 140A. The width w can be in a range of 0.030 inch to 0.095 inch. For example, the width w can be equal to standard filler wire diameters, e.g., 0.030 in, 0.045 in, 0.052 in, 0.063 in, etc. The thickness t of wire 140A can be selected to ensure that wire 140A melts completely in weld puddle 145 and may be dependant on factors such as the power outputs of laser power supplies 130 and 230, the temperature of the weld puddle 145, and the wire feed speed, etc. In some exemplary embodiments the maximum thickness of the wire 140A is in the range of 0.010 to 0.045 inches.

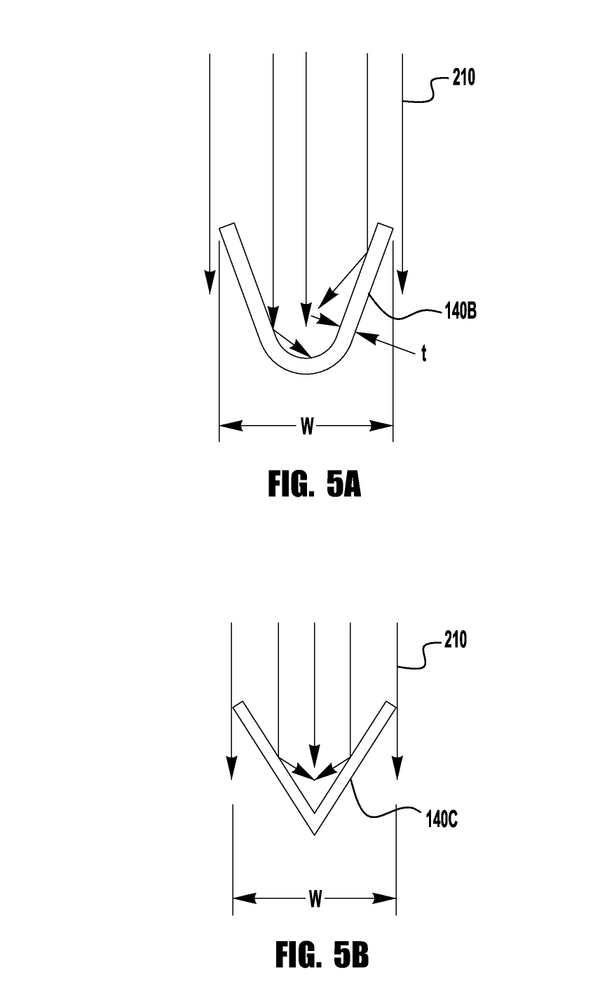

In exemplary embodiments of the present invention, the laser beam 210 impinges on the wire 140A at an angle that is approximately perpendicular to the top surface of wire 140A. Of course, the impingement angle is not limited and may vary ±45° from perpendicular. As illustrated in FIG. 4, to adjust the impingement angle θ, angle α for the laser 220 and/or angle β for the wire 140A can be changed as desired based on welding conditions.

As discussed above, the reflectivity of the surface of wire 140A may be reduced by heating the wire 140A. Alternatively, or in addition, the surface of the wire 140A may be treated or coated (e.g., chemically or mechanically) such that the surface reflectivity is reduced. For example, the surface of wire 140A may be treated chemically such that the surface is pitted. In other embodiments, the surface of wire 140A may be sanded or “roughed” mechanically to reduce its reflectivity. In yet other embodiments, the wire 140A may be coated with a material that will absorb the laser beam 220 but will not adversely affect weld quality. For example, the laser absorbing material may be of the type that will form a slag that can easily be removed or of a type that evaporates when heated further by the weld puddle 145. In some exemplary embodiments, the treatment or coating on the wire 140A is completed during the manufacture of the wire. In other embodiments, the treatment or coating is done as the wire 140A is fed to the weld puddle 145 by wire feeder 150 (or some other device). For example, a surface treatment device can be utilized downstream of the wire feeder 150 which roughens or treats at least one surface of the wire 140A prior to the welding/cladding operation. To the extent only one surface is treated it is the upper surface of the wire 140A, which is impacted by the beam 210 prior to entering the puddle 145.

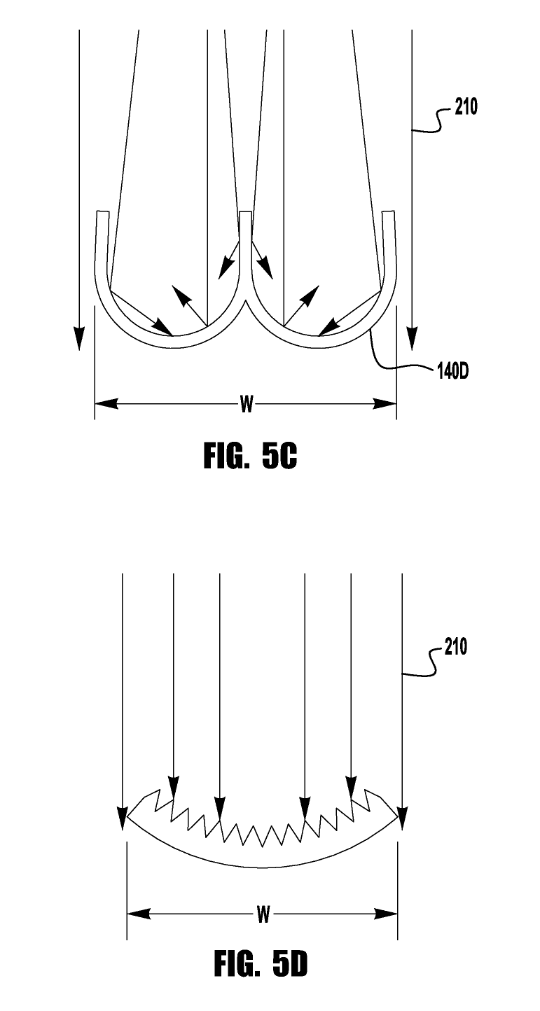

The filler wire of the present invention is not limited to the cross-sectional shape shown in 140A. For example, FIG. 5A illustrates another exemplary embodiment of a filler wire that can be used in the system of FIG. 1. The above discussion with respect to the filler wire 140A is applicable to filler wire 140B and, for brevity, only the relevant differences will be discussed. The cross-sectional shape of filler wire 140B has a more acute curve in the middle than that of filler wire 140A, and after the acute curve, the cross-sectional shape of filler wire 140B extends tangentially at either end. As such, there is a greater probability that the scatter laser beam will again impinge on the wire 140B. Accordingly, more of the laser beam 210 will be absorbed by the wire 140B. Thus, rather than having a surface shape which reflects the beam 210 away from the surface of the wire 140B, the wire 140B has a shape that directs at least some of the beam 210 back onto another point on the surface of the wire 140B. Similar to filler wire 140A discussed above, the projected width w of filler wire 140B can be in a range from 0.030 in to 0.095 in and be equal to standard filler wire diameters, e.g., 0.030 in, 0.045 in, 0.052 in, 0.063 in, etc. Again, the thickness t of wire 140B can be selected to ensure that wire 140B melts completely in weld puddle 145 and may be dependent on factors such as the power outputs of laser power supplies 130 and 230, the temperature of the weld puddle 145, and the wire feed speed, etc. In some exemplary embodiments the maximum thickness of the wire 140B is in the range of 0.010 to 0.045 inches.

Of course, other cross-sectional configurations also fall within the scope of the invention. Some of these configurations are illustrated in FIGS. 5B-D. For example, FIG. 5B illustrates a “V” shaped filler wire cross-section. The thickness t and width w can be as discussed above. In another embodiment as illustrated in FIG. 5, the filler wire 140D has a “W” shaped cross-section. The thickness t and width w of filler wire 140D can be as discussed above. In another exemplary embodiment as illustrated in FIG. 5D, the filler wire 140A′ is similar to filler wire 140A discussed above. However, in filler wire 140A′ the inner surface (the side on which the laser beam 210 impinges) has a profile, e.g., a saw-tooth profile as illustrated, that facilitates the absorption of laser beam 210. Of course, filler wire 140′ is not limited to a saw-tooth profile and other profiles can be used. Because of the different possible cross-sectional shapes that can be used in the system shown in FIG. 1, in some exemplary embodiments, the type of cross-section for the filler wire 140 may be an input to the sensing and control unit 195 or to the wire feeder 150. The cross-sectional input may then be used in determining the power level for laser 220 and/or beam 210, the preheating current from power supply 170, the wire speed setting of wire feeder 150, and/or whether treatment to reduce reflectivity is needed.

In FIG. 1 the weld puddle laser power supply 130, hot wire laser power supply 230, hot wire resistance power supply 170, and sensing and control unit 195 are shown separately for clarity. However, in embodiments of the invention these components can be made integral into a single welding system. Aspects of the present invention do not require the individually discussed components above to be maintained as separately physical units or stand alone structures.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A filler wire for use with a laser, said filler wire comprising:
a first surface that absorbs energy from a laser beam;
a second surface separated from said first surface by a thickness t that is in a range of 0.010 inch to 0.045 inch; and
a cross-sectional shape comprising at least one bend toward said laser beam along a length of said cross-sectional shape,
wherein said cross-sectional shape has a projected width w that is in a range of 0.030 inch to 0.095 inch.

2. The filler wire of claim 1, wherein a reflectivity of said first surface is reduced by at least one of pitting, sanding, and roughing said first surface.

3. The filler wire of claim 1, wherein said first surface comprises a laser absorbing coating.

4. The filler wire of claim 1, wherein said at least one bend is a curve extending along said length of said cross-sectional shape.

5. The filler wire of claim 1, wherein said at least one bend is V-shaped.

6. The filler wire of claim 1, wherein said at least one bend comprises two bends forming a W-shape.

7. The filler wire of claim 4, wherein said first surface has a saw-tooth profile.

8. The filler wire of claim 1, wherein said at least one bend is one bend and said cross-sectional shape further comprises tangentially extending sections at each end of said one bend.

9. A system that uses a laser to heat a filler wire, said system comprising:
a high intensity heat source that heats a workpiece to create a molten puddle;
a feeder system that feeds said filler wire to said molten puddle; and
a laser system that emits a laser beam to heat a length of said filler wire prior to said filler wire entering said molten puddle,
wherein said filler wire comprises,
a first surface that absorbs energy from said laser beam;
a second surface separated from said first surface by a thickness t that is in a range of 0.010 inch to 0.045 inch; and
a cross-sectional shape comprising at least one bend toward said laser beam along a length of said cross-sectional shape,
wherein said cross-sectional shape of said filler wire has a projected width w that is in a range of 0.030 inch to 0.095 inch.

10. The system of claim 9, wherein said feeder subsystem comprises a power supply that supplies a current to said length of said filler wire to heat said length to a threshold temperature, and
wherein said threshold temperature is set such that said current does not create an arc if said filler wire loses contact with said workpiece.

11. The system of claim 10, wherein at least one of a cross-sectional shape and a focus of said laser beam at a point of impact on said filler wire can be adjusted.

12. The system of claim 9, wherein a reflectivity of said first surface of said filler wire is reduced by at least one of pitting, sanding, and roughing said first surface.

13. The system of claim 9, wherein said first surface of said filler wire comprises a laser absorbing coating.

14. The system of claim 9, wherein said at least one bend in said cross-sectional shape of said filler wire is a curve extending along said length of said cross-sectional shape of said filler wire.

15. A method for heating a filler wire using a laser, said method comprising:
heating a workpiece to create a molten puddle;
feeding said filler wire to said molten puddle; and
heating a length of said filler wire using a laser beam prior to said filler wire entering said molten puddle,
wherein said filler wire comprises,
a first surface that absorbs energy from said laser beam;
a second surface separated from said first surface by a thickness t that is in a range of 0.010 inch to 0.045 inch; and
a cross-sectional shape comprising at least one bend toward said laser beam along a length of said cross-sectional shape,
wherein said cross-sectional shape of said filler wire has a projected width w that is in a range of 0.030 inch to 0.095 inch.

16. The method of claim 15, further comprising:
supplying a current to said length of said filler wire to heat said length to a threshold temperature, and
wherein said threshold temperature is set such that said current does not create an arc if said filler wire loses contact with said workpiece.

17. The method of claim 16, further comprising:
adjusting at least one of a cross-sectional shape and a focus of said laser beam at a point of impact on said filler wire.

18. The method of claim 15, further comprising:
reducing a reflectivity of said first surface of said filler wire by at least one of pitting, sanding, and roughing said first surface.

19. The method of claim 15, wherein said first surface of said filler wire comprises a laser absorbing coating.

20. The method of claim 15, wherein said at least one bend in said cross-sectional shape of said filler wire is a curve extending along said length of said cross-sectional shape of said filler wire.
